(19) United States
(12) Patent Application Publication
(10) Pub. No.: US 2014/0210342 A1
(43) Pub. Date: Jul. 31, 2014

(54) CONTROLLING METHOD AND SYSTEM BASED ON THE AUTOMOTIVE LIGHTING SYSTEM ILLUMINATION ANGLE SYNCHRONIZING WITH THE AUTOMOTIVE SPEED

(71) Applicant: Shenzhen Protruly Electronics Co., Ltd, Shenzhen (CN)

(72) Inventors: Min ZHUANG, Shenzhen (CN); Peng LU, Shenzhen (CN)

(21) Appl. No.: 13/918,138

(22) Filed: Jun. 14, 2013

(30) Foreign Application Priority Data
Jan. 25, 2013 (CN) 201310029436.9

(51) Int. Cl. B60Q 1/14

(52) U.S. Cl. CPC B60Q 1/1423
USPC 315/79

(57) ABSTRACT

A controlling method and its application system based on the lighting system illumination angle of the automobile synchronizing with the automotive speed, comprises the following steps: turn on the synchronizing function after received the user's instructions; read and obtain the current automotive speed, look up the prestored correspondence relationship table, find out the specific synchronous angle according to current speed grade; then control the lighting system switching to the found specific illumination angle synchronizing with current speed grade, and achieve the synchronization of illumination angles and automotive speeds. Through applying the method and the application system stated in the present invention, the best illumination effects for an automobile can be achieved. Therefore, the present invention provides a safer lighting system with a better visual effect, which provides conveniences to users.

### CROSS-REFERENCES TO RELATED APPLICATIONS

This application claims the priority of Chinese patent application no. 201310029436.9, filed on Jan. 25, 2013, the entire contents of all of which are incorporated herein by reference.

### FIELD OF THE INVENTION

The present invention relates to the field of automotive electronics, and more particularly to a lighting system synchronize with the automotive speed, and a controlling method based on the lighting system illumination angle synchronizing with the automotive speed.

### BACKGROUND

With the development of science and technology as well as the improvement of people's living standards, driving automobiles is becoming more and more popular, and more and more families own their automobiles.

The existing automotive lighting system adjusts its illumination intensity according to the position of its filamentary cathode. When the cathode locates on its focus, high beam light will be emitted in parallel, and the light is more concentrated with a bigger brightness, and able to illuminate objects higher or farther away, while the cathode of a low beam light locates outside the focus, (between 1 and 2 times of the focus), light emitted will be divergent and will illuminate a larger scope nearby.

However, the viewing angle of human eyes is usually 120 degrees, and when one's attention is concentrated, his viewing angle is about one-fifth, that is 25 degrees only. Resolution sight of people, that is, discernible range without turning one's head, changes with the speed of the automobile and the concentration of one's attention. In the existing automotive lighting systems, both horizontal concentration angle and vertical concentration angle can be manually adjusted, but it is fixed during driving, thus it can't meet the drivers with dynamic perspective synchronizing with speed on demand.

Automotive lighting system of the prior art is working with fixed illumination angle and fixed illumination intensity, either changing the illumination intensity by changing the input power or adjusting the illumination distance through a reflector. The automotive lighting system of the prior art has no synchronizing ability between the viewing angle and the automotive speed, which is sometimes inconvenient for users.

Therefore, the prior art needs to be improved and developed. And the disclosed methods and systems are directed to solve one or more problems set forth above and other problems.

### BRIEF SUMMARY OF THE DISCLOSURE

The technical problems to be solved in the present invention is, aiming at the defects of the prior art, providing a controlling method and an application system based on the automotive lighting system illumination angle synchronizing with the automotive speed, which adds new functions to vehicle loaded lighting system, i.e., its illumination angles synchronizing with the automotive speeds, thus the present invention improves the driving safety and provides conveniences to users.

The technical solution of present invention to solve the said technical problems is as follows:

a controlling method based on the automotive lighting system illumination angle synchronizing with the automotive speed, wherein, it includes:

turn on the synchronization function that makes the illumination angle of automotive lighting system synchronize with the speed of the automobile, after receiving the according user's operation command;

obtain the current driving velocity of the automobile, and transform it into the current speed value; then determine its speed grade according to the current speed value;

based on the determined current speed grade, look up the prestored correspondence relationship table of illumination angle of lighting system synchronizing with each speed grade, find out the specific illumination angle synchronizing with current speed grade under current driving condition; and

control the lighting system switching to the found specific illumination angle synchronizing with the current speed grade, and achieve synchronization between illumination angles and the automotive speeds.

The said controlling method based on the automotive lighting system illumination angle synchronizing with the automotive speed, wherein, the said illumination angles includes a horizontal concentration angle and a vertical concentration angle of the automotive lighting system, wherein, the said horizontal concentration angle is the angle of illumination range on a horizontal surface by the automotive lighting system, and the said vertical concentration angle is the angle of illumination range on a vertical surface by the automotive lighting system.

The said controlling method based on the automotive lighting system illumination angle synchronizing with the automotive speed, wherein, before the said step A it also comprises:

S. preinstall and save a correspondence relationship table of lighting system illumination angle synchronizing with the automotive speed grade.

The said controlling method based on the automotive lighting system illumination angle synchronizing with the automotive speed, wherein, the said step C of controlling the lighting system switching to the found specific illumination angle synchronizing with the current speed grade, and achieving synchronization between illumination angles and automotive speeds, also comprises:

C1: control the illumination angle synchronizing with automotive speed, while keeping the luminous power of the automotive lighting system unchanged.
The said controlling method based on the automotive lighting system illumination angle synchronizing with the automotive speed, wherein, the said step C1 specifically comprises:

when the automotive speed grade is less than 20 km/h, control the horizontal concentration angle of the lighting system illumination angle to be 150 degrees, and vertical concentration angle to be 80 degrees;

when the automotive speed grade is between 20 and 29 km/h, control the horizontal concentration angle of the lighting system illumination angle to be 140 degrees, and vertical concentration angle to be 80 degrees;

when the automotive speed grade is between 30 and 39 km/h, control the horizontal concentration angle of the lighting system illumination angle to be 130 degrees, and vertical concentration angle to be 80 degrees;

when the automotive speed grade is between 40 and 49 km/h, control the horizontal concentration angle of the lighting system illumination angle to be 120 degrees, and vertical concentration angle to be 80 degrees;

when the automotive speed grade is between 50 and 59 km/h, control the horizontal concentration angle of the lighting system illumination angle to be 110 degrees, and vertical concentration angle to be 78 degrees;

when the automotive speed grade is between 60 and 69 km/h, control the horizontal concentration angle of the lighting system illumination angle to be 110 degrees, and vertical concentration angle to be 78 degrees;

when the automotive speed grade is between 70 and 79 km/h, control the horizontal concentration angle of the lighting system illumination angle to be 90 degrees, and vertical concentration angle to be 76 degrees;

when the automotive speed grade is between 80 and 89 km/h, control the horizontal concentration angle of the lighting system illumination angle to be 70 degrees, and vertical concentration angle to be 76 degrees;

when the automotive speed grade is between 90 and 99 km/h, control the horizontal concentration angle of the lighting system illumination angle to be 50 degrees, and vertical concentration angle to be 74 degrees;

when the automotive speed grade is between 100 and 109 km/h, control the horizontal concentration angle of the lighting system illumination angle to be 40 degrees, and vertical concentration angle to be 72 degrees;

when the automotive speed grade is between 110 and 119 km/h, control the horizontal concentration angle of the lighting system illumination angle to be 30 degrees, and vertical concentration angle to be 70 degrees; and

when the automotive speed grade is more than 120 km/h, control the horizontal concentration angle of the lighting system illumination angle to be 30 degrees, and vertical concentration angle to be 70 degrees.
The said controlling method based on the lighting system illumination viewing angle of an automotive synchronizing with the automotive speed, wherein, the said step C further comprises:

C2: based on the determined current automotive speed grade, look up the prestored correspondence table of lighting system illumination intensity synchronizing with each speed grade, find out the specific illumination intensity of the lighting system synchronizing with current speed grade under current driving condition; and

control the lighting system switching to the found specific illumination intensity synchronizing with the current speed grade, and achieve the synchronization between illumination intensity and the automotive speed.

The said controlling method based on the lighting system illumination angle of an automobile synchronizing with the automotive speed, wherein, the said step C2 also comprises: control the luminous power of the lighting system synchronizing with the automotive speed, while controlling the lighting system illumination angles unchanged.

The said controlling method based on the automotive lighting system illumination angle synchronizing with the automotive speed, wherein, the said step C further comprises:

control the lighting system illumination angle and illumination power synchronizing with the automotive speed according to the determined current automotive speed grade

A controlling system based on the automotive lighting system illumination angle synchronizing with the automotive speed, wherein, it comprises:

the receiving module, used to receive user's operation commands to turn on the synchronization function that makes the illumination angle of automotive lighting system synchronize with the speed of the automobile;

the obtaining and determination module, used to obtain the current driving speed of the automobile, and transform it into the current driving speed value, and then determine its speed grade according to the current speed value; and

the controlling module, used to look up the prestored correspondence table of lighting system illumination angles synchronizing with each speed grade, find out the specific illumination angle synchronizing with current speed grade under current driving condition; then control the automotive lighting system switching to the found specific illumination angle synchronizing with current speed grade, and achieve the synchronization between illumination angles and the automotive speeds.

The controlling system based on the automotive lighting system illumination angle synchronizing with the automotive speed, wherein, it comprises:

the storage module, used to preinstall and save a correspondence relationship table of lighting system illumination angle synchronizing with the automotive speed grade; and

the said controlling module, which also comprises:

the first control unit, used to control the illumination angle synchronizing with the automotive speed, while controlling the luminous power of the automotive lighting system unchanged;

the second control unit, used to control the luminous power synchronizing with the automotive speed, while controlling the lighting system illumination angle unchanged;

the third control unit, used to control the illumination angle and luminous power of the automotive lighting system synchronizing with the automotive speed, based on the determined automotive speed grade.

The said illumination angles include both horizontal concentration angle and vertical concentration angle of the automotive lighting system, wherein, the said horizontal concentration angle is the angle of illumination range on a horizontal surface by the automotive lighting system, and the said vertical concentration angle is the angle of illumination range on a vertical surface by the automotive lighting system.

The controlling method and its application system based on the automotive lighting system illumination angle synchronizing with the automotive speed as provided in the present invention, works through obtaining the information such as the automotive speed, the speed changing rate and acceleration, etc. from the velocity acquisition devices (such as CAN, GPS, OBD, etc.), then the controlling system finds out the appropriate concentration ratio matching the current driving status, through the corresponding algorithms process. Finally, control the converging apparatus in the lighting system through controlling devices (such as motor, magnetic induction apparatus, etc.) and achieve the synchronization between the illumination angle and automotive speed. The present invention adds new function to the vehicle loaded lighting system, i.e., the function of illumination angle synchronizing with the automotive speed. Through synchronizing with the automotive speed, automatically controls the concentration ratio, thus controls the illumination intensity and illumination angle, which lowers the inconvenience of switching high beam and low beam manually and brings a better visual effect to drivers, as well as avoids the abuse of high beams by some drivers, and improves the driving safety.

Without requiring any operations from the users during driving, the system can automatically adjust the angles of lighting apparatus under different automotive speeds, thus adjust the size of illumination angles, both broadening the driver's viewing range when the automobile is running at a low speed and making the distant road clearly seeable at a high speed to find the dangers ahead. At the same time, the system can also adjust the illumination intensity, thus saving the power when the automobiles is in a low speed driving condition and making up the weakness that human vision worsens due to physiological responses caused by attention concentrations in a high speed driving condition. Thus greatly improves the driving safety.

### BRIEF DESCRIPTION OF THE DRAWINGS

FIG. 1 illustrates a flow chart of a preferred embodiment of the controlling method of present invention based on the lighting system illumination angle synchronizing with the automotive speed.

FIG. 2 illustrates a diagram of the relationship between human eyes perspectives and automotive lighting system illumination angle in the present invention.

FIG. 3 illustrates a flow chart of the method in the controlling lighting system illumination intensity synchronizing with the automotive speed, based on the lighting system illumination angle synchronizing with the automotive speed in the present invention.

FIG. 4 illustrates a structure diagram of the principal in the controlling system based on the lighting system illumination angle synchronizing with the automotive speed of the present invention.

FIG. 5 illustrates a schematic diagram of principal structure of the controlling module in the controlling system of the present invention.

### DETAILED DESCRIPTION

In order to make the purpose, technical solution and the advantages of the present invention clearer and more explicit, further detailed descriptions of the present invention is stated here, referencing to the attached drawings and some embodiments of the present invention. It should be understood that the detailed embodiments of the invention described here are used to explain the present invention only, instead of limiting the present invention.

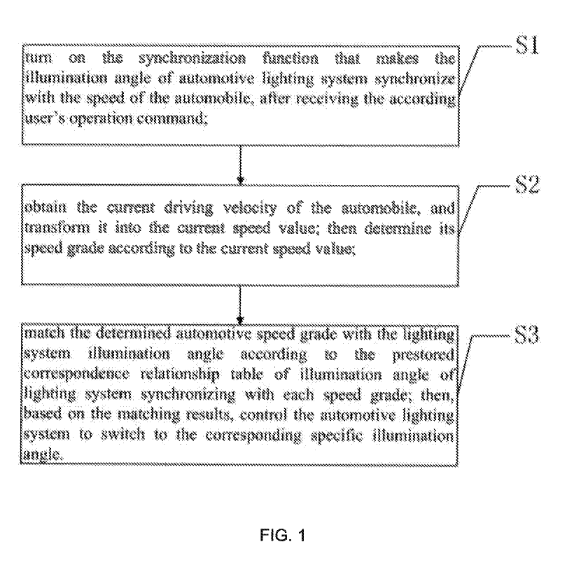

Refer to FIG. 1, which is the flow chart of a preferred embodiment of the controlling method of the present invention based on the lighting system illumination angle synchronizing with the automotive speed.

As shown in FIG. 1, the method comprises the following steps:

S1: turn on the function of lighting system illumination angle synchronizing with the automotive speed, after receiving the user's instructions.

First, the user switches on the device installed in the automobile which is able to accomplish the synchronous function between the lighting system illumination angle and the automotive speed, starting the function. The switching on action could be executed during driving or before driving, whenever the driver wants to use the function.

S2: obtain the current driving velocity of the automobile, and transform it into the current driving speed value; and based on this value, determine the corresponding speed grade of the current automotive velocity.

Through the speed acquisition devices (such as CAN bus, GPS, OBD etc.) to obtain the velocity, its changing rate and the acceleration information, as well as the current speed value, determine the corresponding speed grade of the current speed value according to the preinstalled automotive speed grade table.

In details, as shown in the table 1, 12 speed grades are set for the speeds in the speed grade table.

TABLE 1
The automotive velocities and their corresponding speed grades.

| | Speed range (km/h) | | | | | | | | | | | |
|---|---|---|---|---|---|---|---|---|---|---|---|---|
| | less | | | | | | | | | | | more |
| | than | | | | | | | | | | | than |
| | 20 | 20-29 | 30-39 | 40-49 | 50-59 | 60-69 | 70-79 | 80-89 | 90-99 | 100-109 | 110-119 | 120 |
| Grade | 1 | 2 | 3 | 4 | 5 | 6 | 7 | 8 | 9 | 10 | 11 | 12 |

S3: Based on the determined current speed grade, look up the prestored correspondence table of illumination angles of the lighting system synchronizing with each speed grade, find out the specific illumination angle synchronizing with the current speed grade under the current driving condition;

Control the lighting system switching to the found specific illumination angle synchronizing with the current speed grade, and achieve the synchronization between illumination angles and the automotive speeds.

According to the specific speed grade determined in step S2 above, find out the corresponding specific synchronous lighting system illumination angle in the stored correspondence table of illumination angles synchronizing with the automotive speed grades.

The above said lighting system illumination angles includes a horizontal concentration angle and a vertical concentration angle, wherein, the said horizontal concentration angle is the angle of illumination range on a horizontal surface by the automotive lighting system, and the said vertical concentration angle is the angle of illumination range on a vertical surface by the automotive lighting system.

Particularly, the corresponding relationship table of automotive speed grade and lighting system illumination angle can be processed through the related algorithms, finds out the appropriate concentration ratio matching the current driving status.

The principle of the algorithm used is: under different automotive speeds, the matched illumination angle should be slightly greater than one's perspective, and there is no blind area between the two lamp irradiation areas. Based on the rule that one's resolution sight narrows when the speed of the automotive increases and his attention concentrates, the faster an automotive is, the narrower its illumination angle is. When the automotive is slow, which means the road condition is complicated, thus the irradiation distance should be closer; and when the automotive is running at a high speed, the road condition should be better, and the irradiation distance should be further. According to the law of conservation of energy, for a constant power illumination system, the narrower the irradiation angle is, the stronger the illumination intensity is.

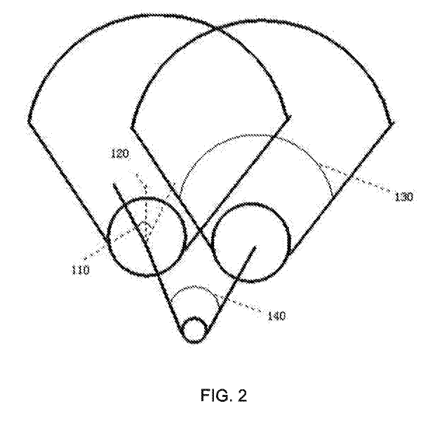

FIG. 2 is showing the relationship diagram of lighting system illumination angle and the perspective of human eyes in the above principal, wherein, 110 represents the vertical concentration angle of the illumination system, 120 represents the horizontal line, 130 represents the horizontal concentration angle, while 140 represents the perspective of human eyes. From FIG. 2, it can be seen that, changes in the illumination angles will induce human visual sense differences.

Based on the said principle of the algorithm above, a correspondence relationship table of lighting system illumination angles synchronizing with the automotive speed grades, that is, a perfect synchronous relationship table between the automotive speed and its lighting system illumination angle is obtained, as shown in table 2 below:

TABLE 2
The automotive velocities and their corresponding lighting system
illumination angles in both horizontal and vertical concentration angles.

| | Speed range (km/h) | | | | | | | | | | | |
|---|---|---|---|---|---|---|---|---|---|---|---|---|
| | less | | | | | | | | | | | more |
| | than | | | | | | | | | | | than |
| | 20 | 20-29 | 30-39 | 40-49 | 50-59 | 60-69 | 70-79 | 80-89 | 90-99 | 100-109 | 110-119 | 120 |
| Horizontal | 150 | 140 | 130 | 120 | 110 | 110 | 90 | 70 | 50 | 40 | 30 | 30 |
| concentration | | | | | | | | | | | | |
| angle (°) | | | | | | | | | | | | |
| vertical | 80 | 80 | 80 | 80 | 78 | 78 | 76 | 76 | 74 | 72 | 70 | 70 |
| concentration | | | | | | | | | | | | |
| angle (°) | | | | | | | | | | | | |

Based on the illumination angle according to the current automotive speed, as found in the table 2 above, the lighting system is controlled so that its illumination angle changes to the according value, so that the synchronization between illumination angles and automotive speed is achieved.

In the embodiment of present invention, before the said step S1, a correspondence relationship table of lighting system illumination angle synchronizing with the automotive speed grade shall be preinstalled and saved.

The step S3 also comprises: the illumination angle is controlled synchronizing with the automotive speed, when the luminous power is controlled unchanged.

Due to the luminous power changes proportionally with the brightness of automotive lighting system and energy consumption, in the specific implementation process, the method of keeping the automotive luminous power as low as possible is generally applied to reduce the energy consumption. Data listed in table 2 above are the lighting system illumination angles applied to achieve the best illumination effects while the luminous power remains unchanged. Thus when an automobile is running, the illumination angle is controlled synchronizing with the automotive speed, while the luminous power of the automotive lighting system is controlled unchanged, and an optimal real time illumination effect is achieved while keeping the lighting system in low power consumption.

A DongFeng Citroen car is selected to be the test object. Before modifications, its lighting system was using a fixed illumination angle and illumination intensity. After modified following the present technical solution, the matching parameters between car speed and both horizontal and vertical concentration angles are shown in the following table 3 (Where, illumination intensity is recorded based on the comparison of illuminations at same position and under same speed, before and after modification. And, the value before modification is considered 100% as a reference.). Comparing to the driver's reaction before modification, the driving comfortable sensation is improved, especially during high speed driving at night, the visual effect gets improved significantly.

TABLE 3
The relative illumination intensity after modifying the lighting system of a
DongFeng Citroen car, adopting the parameters listed below.

| | Car speed (km/h) | | | | | | | | | | | |
|---|---|---|---|---|---|---|---|---|---|---|---|---|
| | <=10 | 20 | 30 | 40 | 50 | 60 | 70 | 80 | 90 | 100 | 110 | >=120 |
| Horizontal | 150 | 140 | 130 | 120 | 110 | 110 | 90 | 70 | 50 | 40 | 30 | 30 |
| concentration | | | | | | | | | | | | |
| angle (°) | | | | | | | | | | | | |
| Vertical | 80 | 80 | 80 | 80 | 78 | 78 | 76 | 76 | 74 | 72 | 70 | 70 |
| concentration | | | | | | | | | | | | |
| angle | | | | | | | | | | | | |
| (°) | | | | | | | | | | | | |
| Illumination | 105 | 109 | 117 | 122 | 127 | 130 | 134 | 136 | 138 | 142 | 149 | 150 |
| intensity | | | | | | | | | | | | |
| after | | | | | | | | | | | | |
| modifycation | | | | | | | | | | | | |
| (%) | | | | | | | | | | | | |

Wherein, the percentage of illumination intensity after modifications is based on that before modifications, which is considered as 100%. Thus, 105% here means, after modifications, when the horizontal concentration angle was adjusted 150° and vertical angle 80°, the illumination intensity of the lighting system became 105% of that before modifications. Other data refer to those listed in the table 3 in turn.

In addition, based on the preferred embodiment above, the present invention can also be achieved in the following manner:

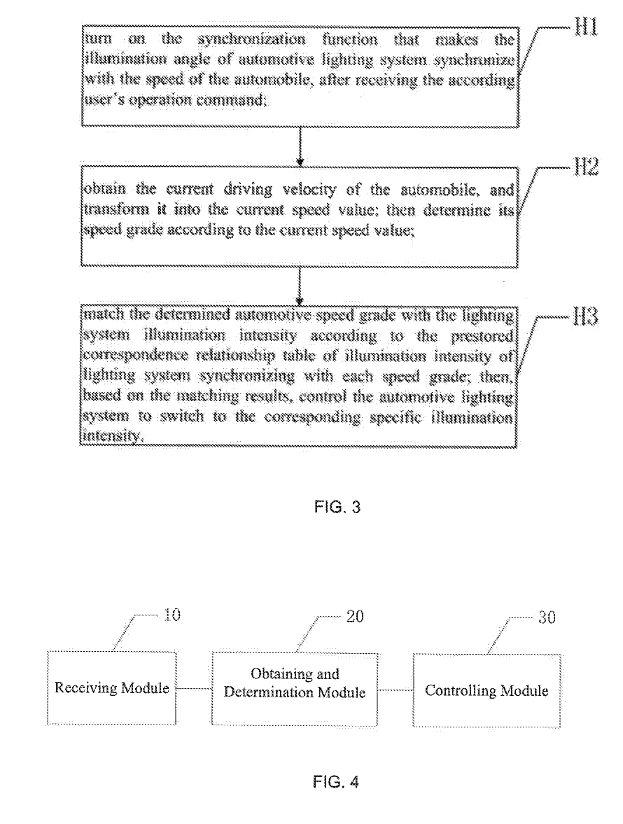

Achieve the synchronization between illumination intensity and the automotive speed based on the correspondence relationship between the automotive speed and the illumination intensity, the detailed embodiment is shown in FIG. 3, the method comprises the following steps:

H1, turn on the synchronous change function between the automotive lighting system illumination intensity and the automotive speed, after receiving the user's instructions.

H2, read and obtain the current automotive driving velocity, and transform it into the velocity value, then, determine its speed grade based on this speed value.

H3, according to the determined automotive speed grade, look up the prestored correspondence relationship table of lighting system illumination intensity synchronizing with each speed grade, find out the specific illumination intensity synchronizing with the current speed grade under the current driving condition.

Control the automobile lighting system switching to the corresponding specific illumination intensity according to the found illumination intensity of the lighting system synchronizing with the current automotive speed grade and achieve the synchronization between the illumination intensity and the automotive speed.

Since the illumination angles of automobile are related to the illumination intensity, it is also possible to achieve the optimal illumination effect through controlling the automotive lighting system intensity.

In the specific embodiment, a corresponding synchronous table between the lighting system illumination intensity and automotive speed grade is preinstalled in the acquisition and determination modules in the device controlling the synchronization between automotive speed and lighting system illumination intensity. Find out the lighting system illumination intensity synchronizing with the current speed grade under current driving condition. Then based on this found specific illumination intensity, control the automotive lighting system switching to this illumination intensity value, and achieve the synchronization between illumination intensity and automotive speed.

The algorithm applied here is the same as in step S3 above, refer to table 3.

In addition, the present invention can also achieve the synchronization between the automotive speed and illumination angle, through the following method, i.e., turning on the function of lighting system illumination angles synchronizing with the automotive speeds after receiving the user's instructions, obtaining the current velocity of the automobile, then determining the current automotive speed grade based on the current velocity value and finally controlling the lighting system illumination power synchronizing with the automotive speed while keeping the automotive lighting system illumination angle unchanged.

Due to the proportional relationship between the luminous power of automotive lighting system and its illumination intensity, it is possible to control the lighting system luminous power synchronizing with the automotive speed while keeping the automotive lighting system illumination angle unchanged.

From the above, the present invention provides a controlling method based on the automotive lighting system illumination angle synchronizing with the automotive speed. This method is shown as below: first receives a current automotive driving velocity value and compares this current automotive driving velocity value to the speed grade prestored in the system, finds out its speed grade, then matches the speed grade which has been founded out with the prestored correspondence relationship table between lighting system illumination angle and automotive speed grade, then obtains the best horizontal concentration angle and vertical concentration angle of the current lighting system, thus achieves the best illumination effects and provides a favorable diving condition.

Based on the embodiment above, the present invention also provides a controlling system based on the lighting system illumination angle of an automotive synchronizing with the automotive speed, as shown in FIG. 4, the system includes:

The receiving module 10, which is used to turn on the function of lighting system illumination angles synchronizing with the automotive speeds after receiving the user's instructions. The function of this module is the same as that stated in step S1 above.

The obtaining and determination module 20, which is used to read and obtain the current automotive driving velocity, and transform it into the current driving speed value, and determine the current speed grade based on this driving speed value. The function of this module is the same as stated in step S2 above.

The controlling module 30, which is used to look up the prestored correspondence relationship table of lighting system illumination angles synchronizing with speed grades, find out the specific synchronous illumination angle according to current speed grade under current driving condition; then control the automotive lighting system switching to the found specific illumination angle synchronizing with the current speed grade, and achieve the synchronization between illumination angles and the automotive speeds. The function of this module is the same as stated in step S3 above.

The above system also comprises a storage module, which is used to preinstall and save a correspondence relationship table of lighting system illumination angle synchronizing with the automotive speed grade.

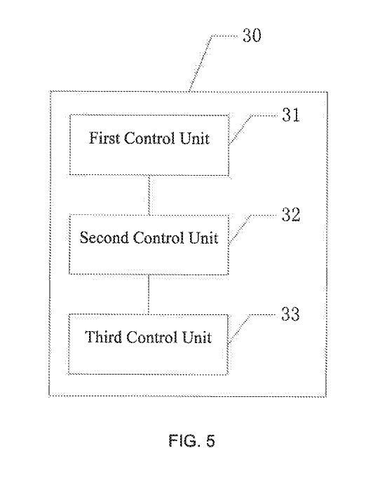

As shown in FIG. 5, the said controlling module 30 also comprises:

The first control unit 31, which is used to control the illumination angle synchronizing with the automotive speed, while controlling the luminous power of the automotive lighting system unchanged.

The second control unit 32, which is used to control the luminous power of the lighting system synchronizing with the automotive speed, while controlling the lighting system illumination angle unchanged.

The third control unit 33, which is used to control the illumination angle and luminous power of the automotive lighting system synchronizing with the automotive speed, based on the determined automotive speed grade.

Since it is possible to control the illumination angles, luminous power and illumination intensity of the lighting system synchronizing with the automotive speed separately, achieving the best illumination effects, thus, there are three modules installed in the controlling module 30, the first, second, and third controlling module, to control these three parameters.

In the system stated above, the said illumination angles include both horizontal concentration angles and vertical concentration angles of the automotive lighting system, wherein, the said horizontal concentration angle is the angle of illumination range on a horizontal surface by the automotive lighting system, and the said vertical concentration angle is the angle of illumination range on a vertical surface by the automotive lighting system.

The present invention discloses a controlling method and its application system based on the lighting system illumination angle of an automobile synchronizing with the automotive speed. The said method comprises the following steps: turn on the synchronization function that the automotive lighting system illumination angle synchronizing with the speed of the automobile, after receiving the user's operation commands; obtain the current velocity of the automobile, transform it into current driving speed value, and based on this speed value, determine the current automotive speed grade, then look up the prestored correspondence relationship table of lighting system illumination angles synchronizing with the speed grades, find out the specific illumination angle synchronizing with the current speed grade under current driving condition; then control the lighting system switching to the found specific synchronous illumination angle matching the current speed grade, and achieve the synchronization between illumination angles and the automotive speeds. When applying the method and the application system mentioned in the present invention, the best illumination effects for the automobile will be achieved, thus the present invention provides a safer lighting system with a better visual effect and provides conveniences to users.

In a summary, the controlling method and its application system based on the lighting system illumination angle of an automobile synchronizing with the automotive speed as provided in the present invention, works through reading the automotive speed, its changing rate and acceleration information from the velocity acquisition devices (such as CAN, GPS, OBD, etc.), then the controlling system finds out the appropriate concentration ratio matching the current driving status, through the corresponding algorithms process. Finally, control the converging apparatus in the lighting system through the controlling devices (such as the motor, the magnetic induction apparatus, etc.) and achieve synchronization between the illumination angle and automotive speeds. The present invention adds new function to the vehicle loaded lighting system, i.e., the function of illumination angle synchronizing with the automotive speed. Through synchronization with the automotive speed, automatically controls the concentration ratio, thus controls the illumination intensity and illumination angle, which lowers the inconvenience of switching high beam and low beam manually and brings a better visual effect to drivers, as well as avoids the abuse of high beams by some drivers, and improves the driving safety.

Without requiring any operations from the users during driving, the system can automatically adjust the angles of lighting device under different automotive speeds, thus adjust the size of illumination angles, both broadening the driver's viewing range when the automobile is running at a low speed and making the distant road clearly seeable at a high speed to find the dangers ahead. At the same time, the system can also adjust the illumination intensity, thus saving the power in a low speed driving condition and making up the weakness that human vision worsens due to physiological responses caused by attention concentrations in a high speed driving condition. Thus greatly improves the driving safety.

It should be understood that, the application of the present invention is not limited to the above examples listed. It will be possible for a person skilled in the art to make modifications or replacements according to the above description, which shall all fall within the scope of the appended claims of the present invention.

What is claimed is:

1. A controlling method based on automotive lighting system illumination angles synchronizing with automotive speeds, comprising the following steps:
A. turn on a synchronization function that makes automotive lighting system illumination angles synchronize with automotive speeds, after receiving a specific user's instructions;
B. obtain a current automotive velocity, and transform it into a current speed value; and determine a speed grade of the current speed value, according to the current speed value;
C. based on the determined current speed grade, look up a prestored correspondence relationship table of lighting system illumination angles synchronizing with each speed grade, find out a specific lighting system illumination angle synchronizing with the current speed grade under a current driving condition; and
control an automotive lighting system switching to the found specific illumination angle synchronizing with the current speed grade, and achieve a synchronization of the illumination angle and the automotive speed.

2. The controlling method based on automotive lighting system illumination angles synchronizing with automotive speeds according to claim 1, wherein the illumination angle includes a horizontal concentration angle and a vertical concentration angle, wherein the horizontal concentration angle is an angle of illumination range on a horizontal surface by the automotive lighting system, and the vertical concentration angle is an angle of illumination range on a vertical surface by the automotive lighting system.

3. The controlling method based on automotive lighting system illumination angles synchronizing with automotive speeds according to claim 1, wherein it also comprises the following step before the step A:
S. preinstall and prestore the correspondence relationship table of lighting system illumination angles synchronizing with automotive speed grades.

4. The controlling method based on automotive lighting system illumination angles synchronizing with automotive speeds according to claim 1, wherein, controlling an automotive lighting system switching to the found specific illumination angle synchronizing with the current speed grade, and achieve a synchronization of the illumination angle and the automotive speed in the step C also comprises:
C1. control the illumination angle synchronizing with the automotive speed, while controlling a luminous power of the automotive lighting system unchanged.

5. The controlling method based on automotive lighting system illumination angles synchronizing with automotive speeds according to claim 4, wherein the step C1 specifically comprises:
when the automotive speed grade is less than 20 km/h, control the horizontal concentration angle of the lighting system illumination angle to be 150 degrees, and the vertical concentration angle to be 80 degrees;
when the automotive speed grade is between 20 and 29 km/h, control the horizontal concentration angle of the lighting system illumination angle to be 140 degrees, and the vertical concentration angle to be 80 degrees;
when the automotive speed grade is between 30 and 39 km/h, control the horizontal concentration angle of the lighting system illumination angle to be 130 degrees, and the vertical concentration angle to be 80 degrees;
when the automotive speed grade is between 40 and 49 km/h, control the horizontal concentration angle of the lighting system illumination angle to be 120 degrees, and the vertical concentration angle to be 80 degrees;
when the automotive speed grade is between 50 and 59 km/h, control the horizontal concentration angle of the lighting system illumination angle to be 110 degrees, and the vertical concentration angle to be 78 degrees;
when the automotive speed grade is between 60 and 69 km/h, control the horizontal concentration angle of the lighting system illumination angle to be 110 degrees, and the vertical concentration angle to be 78 degrees;
when the automotive speed grade is between 70 and 79 km/h, control the horizontal concentration angle of the lighting system illumination angle to be 90 degrees, and the vertical concentration angle to be 76 degrees;
when the automotive speed grade is between 80 and 89 km/h, control the horizontal concentration angle of the lighting system illumination angle to be 70 degrees, and the vertical concentration angle to be 76 degrees;
when the automotive speed grade is between 90 and 99 km/h, control the horizontal concentration angle of the lighting system illumination angle to be 50 degrees, and the vertical concentration angle to be 74 degrees;
when the automotive speed grade is between 100 and 109 km/h, control the horizontal concentration angle of the lighting system illumination angle to be 40 degrees, and the vertical concentration angle to be 72 degrees;
when the automotive speed grade is between 110 and 119 km/h, control the horizontal concentration angle of the lighting system illumination angle to be 30 degrees, and the vertical concentration angle to be 70 degrees; and
when the automotive speed grade is above 120 km/h, control the horizontal concentration angle of the lighting system illumination angle to be 30 degrees, and the vertical concentration angle to be 70 degrees.

6. The controlling method based on automotive lighting system illumination angles synchronizing with automotive speeds according to claim 1, wherein the step C further comprising:
C2. based on the determined current automotive speed grade, look up a prestored correspondence relationship table of lighting system illumination intensities synchronizing with each speed grade, find out a specific illumination intensity of the lighting system synchronizing with the current speed grade under the current driving condition; and
according to the found specific illumination intensity of the lighting system synchronizing with the current speed grade, control the automotive lighting system and switch it to the corresponding illumination intensity, and achieve a synchronization of the illumination intensity and the automotive speed.

7. The controlling method based on automotive lighting system illumination angles synchronizing with automotive speeds according to claim 6, wherein the step C2 further including:
controlling the luminous power to synchronize with the automotive speed, while controlling the lighting system illumination angle unchanged.

8. The controlling method based on automotive lighting system illumination angles synchronizing with automotive speeds according to claim 6, wherein the said step C further including:
controlling the lighting system illumination angle and the luminous power synchronizing with the automotive speed according to the determined current automotive speed grade.

9. A controlling system based on automotive lighting system illumination angles synchronizing with automotive speeds, comprising:
a receiving module, used to receive a user's instructions to turn on a synchronization function that makes automotive lighting system illumination angles synchronize with automotive speeds;
an obtaining and determination module, used to obtain a current automotive velocity, and transform it into the current speed value, and determine its speed grade according to the current speed value; and
a controlling module, used to look up a prestored correspondence relationship table of lighting system illumination angles synchronizing with speed grades, find out a specific illumination angle synchronizing with the current speed grade under current driving condition; then control a lighting system to switch to the found specific illumination angle synchronizing with the current speed grade, and achieve a synchronization of the illumination angle with the automotive speed.

10. The controlling system based on automotive lighting system illumination angles synchronizing with automotive speeds according to claim 9, also comprising:
a storage module, used to preinstall and prestore the correspondence relationship table of lighting system illumination angles synchronizing with each speed grade;
the controlling module also includes:
a first control unit, used to control the illumination angle synchronizing with the automotive speed, while controlling a luminous power of the automotive lighting system unchanged;
a second control unit, used to control the luminous power of lighting system synchronizing with the automotive speed, while controlling the lighting system illumination angle unchanged;
a third control unit, used to control the illumination angle and luminous power of the automotive lighting system synchronizing with the automotive speed, based on the determined automotive speed grade;
the illumination angle includes a horizontal concentration angle and a vertical concentration angle of the automotive lighting system;
the horizontal concentration angle is an angle of illumination range on a horizontal surface by the automotive lighting system; and
the vertical concentration angle is an angle of illumination range on a vertical surface by the automotive lighting system.
